(19) United States
(12) Patent Application Publication
(10) Pub. No.: US 2022/0327401 A1
(43) Pub. Date: Oct. 13, 2022

(54) MACHINE LEARNING FEATURE RECOMMENDER

(71) Applicant: AT&T Intellectual Property I, L.P., Atlanta, GA (US)

(72) Inventors: Joshua Whitney, Richardson, TX (US); Edmond J. Abrahamian, Richmond Heights, MO (US); Prince Paulraj, Coppell, TX (US)

(21) Appl. No.: 17/225,629

(22) Filed: Apr. 8, 2021

(51) Int. Cl. G06N 5/04; G06N 20/00

(52) U.S. Cl. CPC G06N 5/04; G06N 20/00

(57) ABSTRACT

The described technology is generally directed towards a machine learning feature recommender, for use in connection with a feature store. By collecting data and recommending machine learning features to users based on collected data, embodiments can facilitate data scientists' discovery of features that have been used by their colleagues and that are likely to make their machine learning models more performant. The disclosed machine learning feature recommender can reduce the effort involved in developing machine learning models.

### TECHNICAL FIELD

The subject application is related to machine learning and artificial intelligence, and in particular to search and recommendation of features for use in connection with machine learning models.

### BACKGROUND

When a data scientist sets out to solve a business problem with a machine learning model, they are faced with the daunting task of feature engineering: developing variables that are understandable to a machine learning model and that will help the model learn what the data scientist intends. Feature cleaning and engineering is estimated to account for around 80% of a data scientist's time. Feature engineering is even more difficult when a machine learning model is intended for real-time production, in which case the machine learning model may be designed to gather its features and return scores in fractions of a second. Feature reuse can streamline feature engineering, and so feature reuse can be crucial to the business success of a mature data science organization.

In the past several years, feature stores, such as the HOPSWORKS® feature store, have become popular among companies that rely heavily on machine learning and artificial intelligence. We anticipate feature stores will increase in popularity, with more companies releasing commercially available feature stores.

In today's feature stores, data scientists share their features in a central repository with a searchable metadata layer over the top. This allows data scientists to search for features that already exist. However, today's feature stores fall short by requiring the data scientist to understand the features they want. If the data scientist is not aware of an existing feature that might help them to build a machine learning model, the data scientist is unlikely to find that feature.

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example feature store comprising a recommendation engine, in accordance with various aspects and embodiments of the subject disclosure.

FIG. 2 illustrates another example feature store comprising a recommendation engine, in accordance with various aspects and embodiments of the subject disclosure.

FIG. 3 illustrates example user survey interfaces to gather input data for use in recommending features, in accordance with various aspects and embodiments of the subject disclosure.

FIG. 4 illustrates an example search interface which can be used to gather input data and to deliver feature recommendations, in accordance with various aspects and embodiments of the subject disclosure.

FIG. 5 illustrates an example feature recommendation, in accordance with various aspects and embodiments of the subject disclosure.

FIG. 6 illustrates an example interface to receive feature importance information, in accordance with various aspects and embodiments of the subject disclosure.

FIG. 7 illustrates an example machine learning feature store comprising features associated with multiple different domains, in accordance with various aspects and embodiments of the subject disclosure.

FIG. 8 is a flow diagram representing example operations of a system that provides a feature store, in accordance with various aspects and embodiments of the subject disclosure.

FIG. 9 is a flow diagram representing another set of example operations of a system that provides a feature store, in accordance with various aspects and embodiments of the subject disclosure.

FIG. 10 is a flow diagram representing another set of example operations of a system that provides a feature store, in accordance with various aspects and embodiments of the subject disclosure.

FIG. 11 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards a machine learning feature recommender, for use in connection with a feature store. By collecting data and recommending machine learning features to users based on collected data, embodiments can facilitate data scientists' discovery of features that have been used by their colleagues and that are likely to make their machine learning models more performant. The disclosed machine learning feature recommender can reduce the effort involved in developing machine learning models.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

The terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

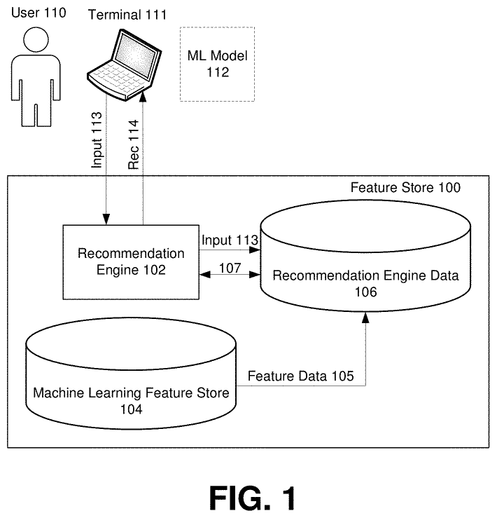

FIG. 1 illustrates an example feature store comprising a recommendation engine, in accordance with various aspects and embodiments of the subject disclosure. FIG. 1 includes example feature store 100, and illustrates interactions of the feature store 100 with a user 110 (also referred to herein as a data scientist 110) via a terminal 111, wherein the user 110 is interested in finding features for a machine learning (ML) model 112. The feature store 100 includes a recommendation engine 102, a machine learning feature store 104, and recommendation engine data 106.

In FIG. 1, the user 110 can supply an input 113 to the recommendation engine 102 via terminal 111. Input 113 can comprise any of a variety of data that can be used to determine a feature recommendation, as described further herein. The recommendation engine 102 can optionally be configured to store the input 113 in the recommendation engine data 106. The recommendation engine data 106 can also include feature data 105, which can identify and describe the various machine learning features included in the machine learning feature store 104. At operation 107, the recommendation engine 102 can be configured to use the input 113, optionally along with other data stored in the recommendation engine data 106, to determine a feature recommendation 114. The feature recommendation 114 can comprise identification(s) of one or more features stored in the machine learning feature store 104, for delivery to the user 110. The recommendation engine 102 can send the feature recommendation 114 to the terminal 111 or to another device associated with the user 110, or the recommendation engine 102 can store the feature recommendation 114 in a user 110 account, accessible by the user 110 when the user logs into the feature store 100.

In some embodiments, the illustrated recommendation engine 102 can be configured to recommend machine learning features. The recommendation engine 102 can be added to a feature store 100, and the feature store 100 can include numerous other elements not illustrated herein for the sake of brevity. In particular, the feature store 100 can comprise feature selection and delivery mechanisms (not illustrated in FIG. 1) to deliver a selected feature to a user 110.

A data scientist user 110 that comes to a feature store 100 to find machine learning features that will be relevant to his or her machine learning model 112 can have features recommended via feature recommendation 114, wherein the recommended features can comprise features likely to be incorporated into the machine learning model 112. The recommended features can comprise features likely to lead to increases in ML model 112 performance. For example, when a data scientist user 110 provides an input 113 comprising a search for existing features, namely features stored in the machine learning feature store 104, the recommendation engine 102 can include feature recommendations 114 in results of that search, and the feature recommendations 114 can optionally be ordered by their likely relevance to the data scientist's 110 interest.

In some embodiments, the feature store 100 can be configured to provide several phases of user experience for a data scientist user 110. A first time the user 110 signs on to the feature store 100, the user 110 can be asked a few questions such as, what kind of model are you building, who is the model for, etc. Answers to these questions can constitute an input 113. Such survey questions acquire input 113 to make some initial feature recommendations 114 and avoid the cold-start problem. A few feature recommendations 114 can initially be made by the recommendation engine 102 and the user 110 can choose which features they wish to explore further. User selected features from among feature recommendations 114 can be used as a further input 113 to feed back into the recommendation engine 102, e.g., by storing feature selection information in the recommendation engine data 106. In an embodiment, the recommendation engine 102 can be configured to learn which recommended features are selected for use by which users, and recommendation engine 102 can recommend features having a high probability of use by a given user 110.

In a second user experience phase, the data scientist user 110 can search for a feature they think will be useful. The entered search terms from user 110 can constitute and input 113. The recommendation engine 102 can be configured to include feature recommendations 114 in search results, and/or to rank search results by likelihood of use or selection by the user 110. The recommendation engine 102 can furthermore provide feature recommendations 114 comprising features that other users with similar interests (e.g., similar to the entered search terms) have found useful.

In an example third user experience phase, another user (other than user 110) has uploaded a feature that the first user 110 might find useful, according to the recommendation engine 102 and based on prior input 113 received from the first user 110. The recommendation engine 102 can be configured to provide a feature recommendation 114 comprising a push alert to the first user 110, notifying the first user 110 of the new feature they might like to use.

In an example fourth user experience phase, the user 110 has previously used features from the feature store 100 to build a model. Such previously used features can constitute input 113. Furthermore, the user 110 can upload feature importance data from their model, and the feature importance data can constitute further input 113. The recommendation engine 102 can be configured to account for the feature importance data in its future feature recommendations 114 to user 110 as well as to other users.

In summary, feature recommendation engine 102 can be configured to recommend different machine learning features to a data scientist or engineer user 110 to include in their models, such as ML model 112, to improve model accuracy and performance. In order to avoid the cold-start problem (where the recommendation engine 102 doesn't know what features to recommend with no information about a user 110), the recommendation engine 102 can be configured ask the user 110 questions the first time the user 110 signs onto the feature store 100. After answering the onboarding questions, the recommendation engine 102 can recommend some features for the data scientist 110 to include in their model 112. When the data scientist 110 searches for a feature, the recommendation engine 102 can surface features that may be useful and relevant to the data scientist 110. When a user adds a new feature to the store, other users for whom the feature is deemed relevant by the recommendation engine 102 can receive a notification suggesting they add the feature to their models. When a data scientist 110 builds a model using features from the feature store 100, the user 110 can upload their feature importance information to the feature store 100 so that the recommendation engine 102 can identify the strongest features for future users.

For the purpose of this disclosure, “feature” is a term or art in machine learning, and refers to an individual measurable property or characteristic of a phenomenon being observed, e.g., a variable. As a practical matter, a feature can be associated with a mechanism for a machine model to retrieve the feature, e.g., a uniform resource locator (URL) or other address that links to feature data. Machine learning is applied in many different domains, e.g., weather prediction, spam detection, computer vision, speech recognition, etc., each domain having different features that are expected to be of importance. Furthermore, sometimes unexpected features can be important in any given domain.

For example, for a model that predicts the weather in Dallas, the temperature measured on the nearby coast, e.g., in Houston, may be important, while the inland temperature in Amarillo might not be particularly important. Alternatively, the opposite could be true—the temperature in Amarillo may be quite useful for Dallas weather predictions. By building up recommendation engine data 106, embodiments of this disclosure can better understand the features that are likely to be important across a variety of different domains. Furthermore, embodiments of this disclosure can usefully suggest features that might be unexpected by a particular data scientist. For example, while features such as hospital visits are expected to be important in modeling seasonal flu outbreaks, it might not be expected that internet searches for flu symptoms made from devices located in a particular region can also strongly correlate to the likelihood of a flu outbreak in that region. Embodiments of this disclosure are therefore useful to recommend both powerful features and unexpected features.

In some embodiments, the recommendation engine 102 can be “domain agnostic” in that it can be configured to make feature recommendations in any of multiple different domains. The recommendation engine 102 can determine a domain of ML model 212 based on input 113, and the recommendation engine 102 can make feature recommendations 114 based in part on the determined domain of ML model 212. Different domains can have different useful features, and by building recommendation engine data 106, the recommendation engine 102 can build up specialized knowledge about important features across multiple different domains.

In some embodiments, the recommendation engine 102 can itself be configured as a machine learning model. The recommendation engine 102 can be trained to use recommendation engine data 106, including, e.g., inputs 113 and feature data 105, to determine recommendations 114 that have relatively higher probability of use by the user 110. When a feature is selected for use in a ML model 112 by the user 110, such selection can reinforce future recommendations of the selected feature to similar users. Alternatively, features that are not selected for use can be assigned reduced likelihoods of recommendation to similar users.

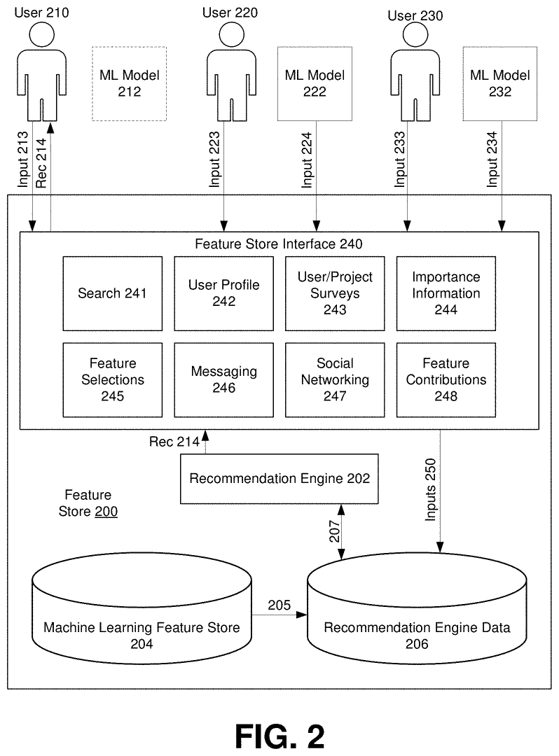

FIG. 2 illustrates another example feature store comprising a recommendation engine, in accordance with various aspects and embodiments of the subject disclosure. FIG. 2 includes example feature store 200, and illustrates interactions of the feature store 200 with multiple users 210, 220, 230, wherein the user 210 is interested in finding features for a machine learning (ML) model 212, and the users 220, 230 have previously built machine learning models 222, 232, respectively, using features from the feature store 200. FIG. 2 does not illustrate user terminals, such as 111 in FIG. 1, however it is understood that the users 210, 220, 230 interact with feature store 200 via user computing devices. The feature store 200 includes a feature store interface 240, a recommendation engine 202, a machine learning feature store 204, and recommendation engine data 206. The feature store interface 240 comprises search 241, user profile 242, user/project surveys 243, importance information 244, feature selections 245, messaging 246, social networking 247, and feature contributions 248.

In FIG. 2, the various components 241-248 of the feature store interface 240 can comprise, e.g., components that interact with users 210, 220, 230. The components 241-248 can each collect different types of input data, e.g., data included in inputs 213, 223, 224, 233, and 234. The inputs 213, 223, 224, 233, and 234 can be stored as inputs 250 in the recommendation engine data 206 for use by the recommendation engine 202 in configuring feature recommendations, such as feature recommendations 214, to any of the users, e.g., to user 210. Feature data 205 from the machine learning feature store 204 can also be included in the recommendation engine data 206. The recommendation engine 202 can be configured to use an input 213, optionally along with other input data collected from a user 210, to perform an operation 207 on recommendation engine data 206, in order to configure the feature recommendation 214.

The search 241 component can comprise a search interface into which the users 210, 220, 230 can type search terms. Entered search terms can be stored along with user identification/profile information in the recommendation engine data 206. User profile 242 can comprise one or more interfaces into which users 210, 220, 230 can provide user profile information, e.g., name, employment information, interests, ML projects, favorite features, or other information. Entered user profile information can be stored in the recommendation engine data 206. User/project surveys 243 can comprise interfaces that request information from users 210, 220, 230 regarding their interest areas, e.g., their ML models 212, 222, 232. User/project survey data can be stored in the recommendation engine data 206.

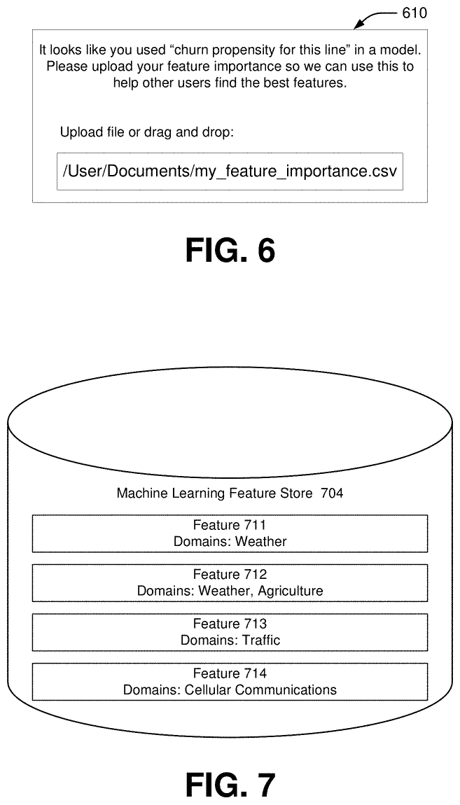

Importance information 244 can comprise an interface to receive uploaded feature importance files, e.g., inputs 224 and 234, generated by completed ML models 222, 232. FIG. 6 provides an example feature importance information interface. ML models 222, 232 can track the relative importance, or weight, of the features they use, and can provide importance information to importance information 244. Received importance information can be stored in the recommendation engine data 206, along with corresponding information about the ML models 222, 232 and users 222, 232 that provided the importance information.

Feature selections 245 can comprise features selected for use by the users 210, 220, 230. Feature selections 245 can be stored in the recommendation engine data 206. Messaging 246 can provide a mechanism to communicate feature recommendations 214 to the users 210, 220, 230. In some cases, feature recommendations 214 can be included in other interface components, e.g., with search results provided via search 214, or in a user profile page supported by user profile 242. In other embodiments, messaging 246 can be used to surface feature recommendations 214 to a user 210.

Social networking 247 can comprise social networking connections between users 210, 220, 230. Social networking data can be stored in the recommendation engine data 206. Feature contributions 248 can comprise features added to the machine learning feature store 204 by the users 210, 220, 230. Identifications of the features contributed by a user can be stored in the recommendation engine data 206.

The recommendation engine 202 can be configured to use the data stored in recommendation engine data 206 to determine feature recommendations 214, which recommend features stored in the machine learning feature store 204 to a particular user 210, optionally in connection with a particular ML model 212 under development by the user 210. The recommendation engine 202 can be configured to use probability of use of a feature, e.g., the probability that the user 210 will select and retrieve a recommended feature from the machine learning feature store 204, as a proxy for utility of the feature to the user 210, and so in some embodiments, the recommendation engine 202 can be configured to formulate recommendations by maximizing a function indicative of probability of selection and/or use by a user 210 associated with known searches, user profile, surveys, and other collected data as described herein. In another embodiments, the recommendation engine 202 can be configured to recommend features having relatively high utility and/or importance scores in connection with a give type of ML model 212 to be built by a user 210. In a still further embodiment, the recommendation engine 202 can be configured to recommend features based on a combination of probability of use scores and feature utility/importance scores.

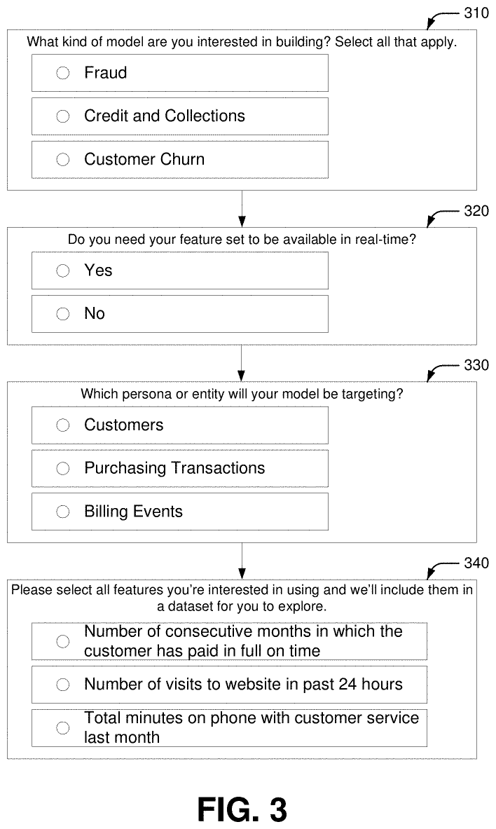

FIG. 3 illustrates example user survey interfaces to gather input data for use in recommending features, in accordance with various aspects and embodiments of the subject disclosure. FIG. 3 comprises a series of user/project survey interfaces 310, 320, 330, 340 which can be presented to a user, e.g., by a user/project surveys component 243 such as illustrated in FIG. 2.

An example first user/project survey interface 310 can collect a machine learning domain input, indicative of the domain of a user's ML project. For example, first user/project survey interface 310 asks, “What kind of model are you interested in building? Select all that apply.” A few example selectable domains are illustrated, including, “Fraud,” “Credit and Collections,” and “Customer Churn.” A wide variety of other domain selections can be included in particular embodiments. In some cases, generalized domain selections can be followed by more specific selections.

An example second user/project survey interface 320 can collect an input indicating whether the features for a user's ML project include real-time features. For example, second user/project survey interface 320 asks, “Do you need your feature set to be available in real-time?” The user can select “Yes” or “No”. Some features are available in real-time and others are not, and so the user's selection can be used to narrow the features recommended to the user 210 to include only features available in real-time, when appropriate.

An example third user/project survey interface 330 can collect an input indicative of a target of a user's ML project. For example, third user/project survey interface 330 asks, “Which persona or entity will your model be targeting?” A few example selectable targets are illustrated, including, “Customers,” “Purchasing Transactions,” and “Billing Events.” A wide variety of other target selections can be included in particular embodiments.

An example fourth user/project survey interface 340 can collect an input indicative of a user's features of interest. For example, fourth user/project survey interface 340 asks, “Please select all features you're interested in using and we'll included them in a dataset for you to explore.” A few example selectable features of interest are illustrated, including, “Number of consecutive months in which the customer has paid in full on time,” “Number of visits to website in past 24 hours,” and “Total minutes on phone with customer service last month.” A wide variety of other features of interest can be included in particular embodiments.

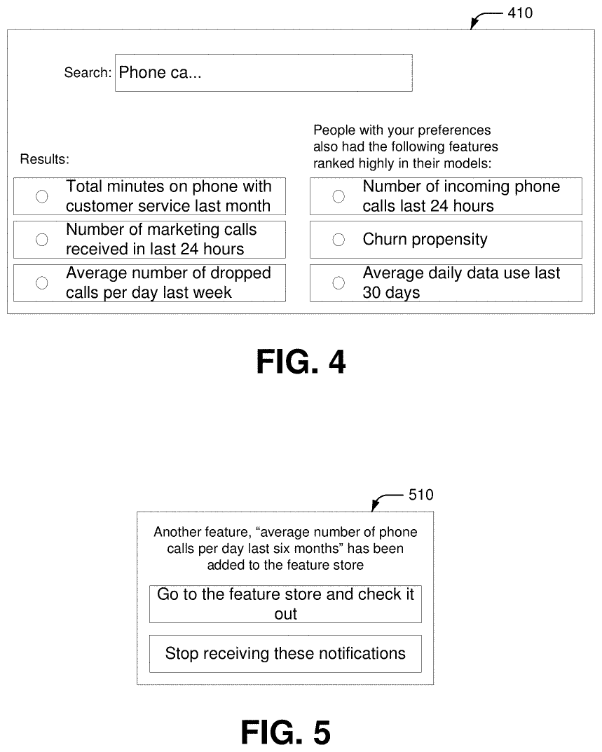

FIG. 4 illustrates an example search interface which can be used to gather input data and to deliver feature recommendations, in accordance with various aspects and embodiments of the subject disclosure. The example search interface 410 includes a text entry field into which a user can enter search terms, search results based on the search terms entered in the text entry field, and additional recommendations based on both the search terms and other user information. The search interface 410 can be supported, e.g., by a search 241 component of a features store 200, illustrated in FIG. 2.

In FIG. 4, the search results are illustrated in a left column, and additional recommendations are illustrated in a right column. A user has entered “Phone ca . . . ” in the text entry field, and example search results have been displayed in the search interface 410 based on the user's entry in the text entry field. The search results include features available in a machine learning feature store such as 204, illustrated in FIG. 2. The search results can include, inter alia, feature recommendations 214 generated by recommendation engine 202, or the search results can optionally be ranked by recommendation engine 202. Example search results include a first selectable feature, “Total minutes on phone with customer service last month,” a second selectable feature, “Number of marketing calls received in last 24 hours,” and a third selectable feature, “Average number of dropped calls per day last week.”

Example additional recommendations have also been displayed in the search interface 410 based on the user's entry in the text entry field. The additional recommendations also include features available in a machine learning feature store such as 204, illustrated in FIG. 2. The additional recommendations can include feature recommendations 214 generated by recommendation engine 202, or the additional recommendations can optionally be ranked by recommendation engine 202. Example additional recommendations include a first selectable feature, “Number of incoming phone calls last 24 hours,” a second selectable feature, “Churn propensity,” and a third selectable feature, “Average daily data use last 30 days.”

FIG. 5 illustrates an example feature recommendation, in accordance with various aspects and embodiments of the subject disclosure. The feature recommendation 510 can be sent to a user as a push type notification, to notify the user of a recently stored feature in a feature store. The feature recommendation 510 can be sent to a user for whom the recently stored feature matches user data such as user searches, user profile data, etc. The feature recommendation 510 includes example notification text, “Another feature, “average number of phone calls per day last six months” has been added to the feature store. The feature recommendation 510 further includes a selectable function button, “Go to the feature store and check it out” which can link to a feature store website. The feature recommendation 510 further includes a selectable function button, “Stop receiving these notifications” which can send an unsubscribe message to unsubscribe a user from push type feature recommendations.

FIG. 6 illustrates an example interface to receive feature importance information, in accordance with various aspects and embodiments of the subject disclosure. The example interface 610 includes a text entry/file drag and drop field into which a user 210 can identify or place a feature importance file. The interface 610 can be supported, e.g., by an importance information 244 component of a feature store 200, illustrated in FIG. 2. The feature importance file can be received at the feature store 200 via interface 610 and stored in the recommendation engine data 206.

FIG. 7 illustrates an example machine learning feature store comprising features associated with multiple different domains, in accordance with various aspects and embodiments of the subject disclosure. The illustrated machine learning feature store 704 can implement a machine learning feature store 204 or a machine learning feature store 104. The machine learning feature store 704 can include multiple stored features, for example, features 711, 712, 713, and 714. Each feature 711, 712, 713, and 714 can be associated with metadata such as title, source, description, etc., along with metadata indicating feature domains, as shown. Feature 711 is illustrated as associated with a weather domain, feature 712 is illustrated as associated with a weather domain and an agriculture domain, feature 713 is illustrated as associated with a traffic domain, and feature 714 is illustrated as associated with a cellular communications domain. Because machine learning model engineering can span a wide range of applicable domains, storing feature domain information along with features can assist with identifying feature recommendations 214 by a recommendation engine 202.

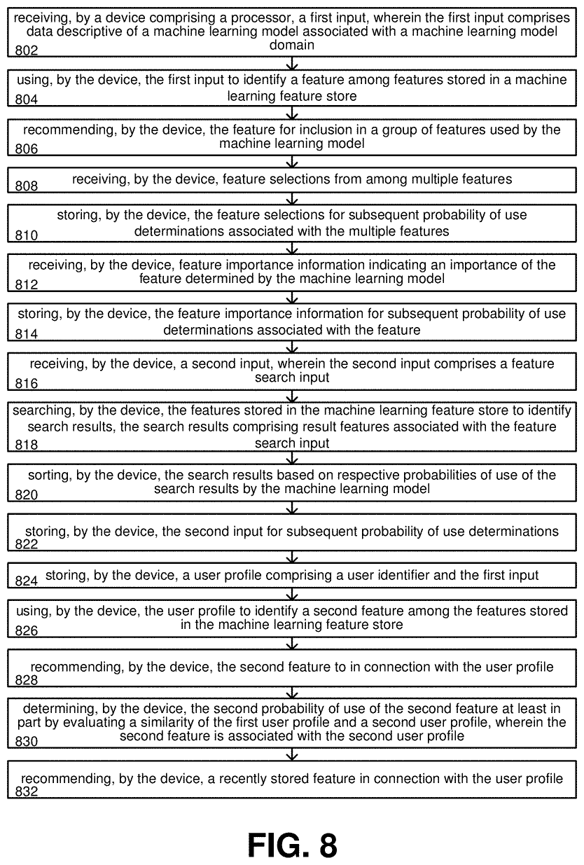

FIG. 8 is a flow diagram representing example operations of a system that provides a feature store, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

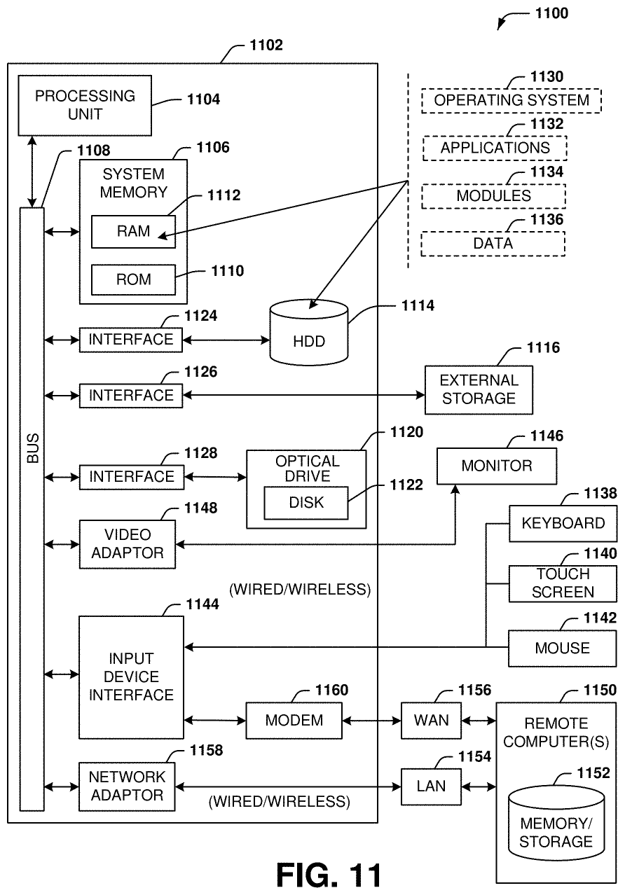

The operations illustrated in FIG. 8 can be performed, for example, by one or more computing devices such as illustrated in FIG. 11, which can implement a feature store 200 such as illustrated in FIG. 2. Example operation 802 comprises receiving, by a device comprising a processor, a first input 213, wherein the first input 213 comprises data descriptive of a machine learning model 212 associated with a machine learning model domain. The data descriptive of the machine learning model 212 can comprise any of the various inputs described herein. For example, as illustrated in FIG. 3, the data descriptive of the machine learning model 212 can include a first indication of a machine learning model domain received via an interface such as 310, a second indication of whether the group of features used by the machine learning model 212 comprises real-time features available in real-time received via an interface such as 320, a third indication of a target associated with the machine learning model 212 received via an interface such as 330, or a fourth indication of which features are of interest in connection with the machine learning model 212, received via an interface such as 340.

Example operation 804 comprises using, by the device, the first input 213 to identify a feature among features stored in a machine learning feature store 204. The features stored in the machine learning feature store 204 can be associated with multiple different machine learning model domains, as illustrated in FIG. 6. Identifying a feature in the machine learning feature store 204 can be based on a probability of use of the feature by the machine learning model 212, e.g., of selection of the feature by the user 210, being higher than other probabilities of use of other features stored in the machine learning feature store 204. The first input 213 can be used, along with other inputs received from user 210, to determine the probability of use of the feature. Probabilities of use can be determined by the recommendation engine 202 in view of recommendation engine data 206. Example operation 806 comprises recommending, by the device, e.g., by the recommendation engine 202, the feature, e.g., by sending feature recommendation 214 to the user 210, for inclusion in a group of features used by the machine learning model 212.

Operations 808-832 illustrate additional optional approaches to collect and use inputs to improve feature recommendations such as 214. Operations 808-810 are directed to collecting and storing user feature selections to improve feature recommendations. In an example, using the first input 213 to identify the feature can comprise using the first input 213 to identify multiple features among the features stored in the machine learning feature store 204. The feature recommendation 214 can recommend the multiple features. The multiple probabilities of use of the multiple recommended features 214 by the machine learning model 212 can be higher than other probabilities of use of the other features stored in the machine learning feature store 204. The recommending operation 806 can comprise recommending the multiple features 214 for inclusion in the group of features used by the machine learning model 212. Example operation 808 comprises receiving, by the device, feature selections, e.g., selections made by user 210, from among the multiple features 214. Example operation 810 comprises storing, by the device, the feature selections, e.g., in recommendation engine data 206, for subsequent probability of use determinations associated with the multiple features 214.

Operations 812-814 are directed to collecting and storing feature importance information. Example operation 812 comprises receiving, by the device, feature importance information, e.g., via an interface such as 610 illustrated in FIG. 6, indicating an importance of a feature determined by a machine learning model. Example operation 814 comprises storing, by the device, e.g., in recommendation engine data 206, the feature importance information for subsequent probability of use determinations. In some scenarios, after the ML model 212 is built, the ML model 212 can also report back feature importance information regarding the feature that was recommended via feature recommendation 214.

Operations 816-822 are directed to search information. Example operation 816 comprises receiving, by the device, a second input, e.g., a second input 213, wherein the second input 213 comprises a feature search input. Example operation 818 comprises searching, by the device, the features stored in the machine learning feature store 204 to identify search results, the search results comprising result features associated with the feature search input 213. Example operation 820 comprises sorting, by the device, e.g., by the recommendation engine 202, the search results based on respective probabilities of use of the search results by the machine learning model 212. Example operation 822 comprises storing, by the device, the second input 213, e.g., in the recommendation engine data 206, for subsequent probability of use determinations.

Operations 824-832 are directed to user profile information. Example operation 824 comprises storing, by the device, a user profile comprising a user identifier, e.g., of user 210, and the first input 213. Example operation 826 comprises using, by the device, the user profile to identify a second feature among the features stored in the machine learning feature store 204. The second feature can be identified based on a second probability of use of the second feature in connection with the user profile being higher than other probabilities of use of other features stored in the machine learning feature store 204. Example operation 828 comprises recommending, by the device, e.g., by a second feature recommendation 214, the second feature to in connection with the user profile.

Example operation 830 comprises determining, by the device, e.g., by the recommendation engine 202, the second probability of use of the second feature at least in part by evaluating a similarity of the user profile, e.g. of user 210, and a second user profile, e.g., of user 220, wherein the second feature is associated with the second user profile of user 220. The recommendation engine 202 can recommend features based on similarity between user profiles by identifying a degree of similarity and recommending features used by one user 220 to another user 210. Example operation 830 comprises recommending, by the device, a recently stored feature, e.g., a feature stored in machine learning feature store 204 by user 220 in the past week, in connection with the user profile, e.g., of user 210. Operation 830 can also be based in part on similarity between user profiles of user 220 and user 210.

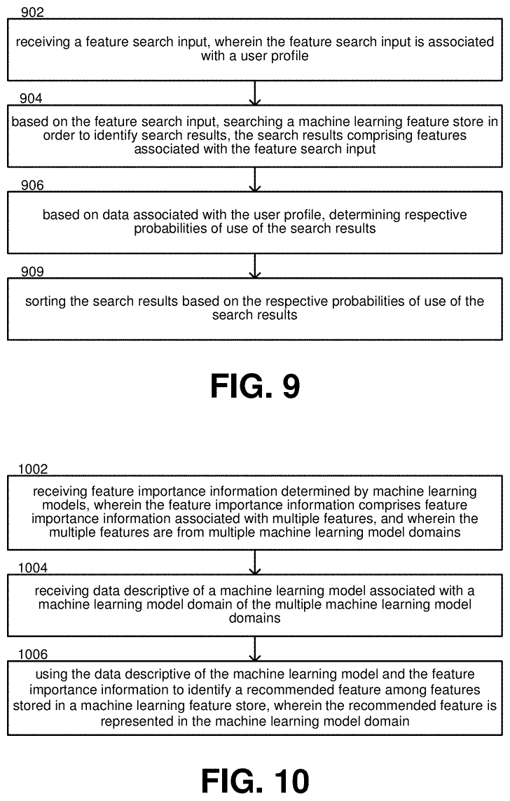

FIG. 9 is a flow diagram representing another set of example operations of a system that provides a feature store, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by one or more computing devices such as illustrated in FIG. 11, which can implement a feature store 200 such as illustrated in FIG. 2. The illustrated operations pertain to search. Example operation 902 comprises receiving a feature search input, e.g., input 213, wherein the feature search input 213 is associated with a user profile, e.g., of user 210. The data associated with the user profile can comprise, inter alia, model data descriptive of a machine learning model 212 associated with a machine learning model domain.

Example operation 904 comprises, based on the feature search input 213, searching a machine learning feature store 204 in order to identify search results, the search results comprising features associated with the feature search input 213. Example operation 906 comprises, based on data associated with the user profile of user 210, determining respective probabilities of use of the search results. Determining the respective probabilities of use of the search results can be based on data associated with the user profile of user 210 as well as data associated with other users, e.g., data associated with a second user profile, of a second user 220. For example, user 220's prior search history and feature selections can be used to determine probabilities of use of certain features by user 210, especially when user 210 has a similar profile, indicating similar interests and projects, as user 220. Feature importance information determined by a machine learning model 222 associated with the second user profile, of user 220, can also be used to determine probabilities of use of features by user 210 in connection with ML model 212. Example operation 908 comprises sorting the search results based on the respective probabilities of use of the search results. The sorted search results can be provided, e.g., as recommendation 214, to the user 210.

FIG. 10 is a flow diagram representing another set of example operations of a system that provides a feature store, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 10 can be performed, for example, by one or more computing devices such as illustrated in FIG. 11, which can implement a feature store 200 such as illustrated in FIG. 2. The illustrated operations pertain to feature importance information. Example operation 1002 comprises receiving feature importance information, e.g., as inputs 224 and 234, determined by machine learning models 222, 232, wherein the feature importance information 224, 234 comprises feature importance information associated with multiple features machine learning models 222, 232, and wherein the multiple features are from multiple machine learning model domains. For example, the machine learning models 222, 232 can be from multiple different machine learning models domains, e.g., weather, cellular networking, disease modeling, etc. The received feature importance information 224, 234 can be stored in the recommendation engine data 206.

Example operation 1004 comprises receiving data, e.g., input 213, descriptive of a machine learning model 212 associated with a machine learning model domain of the multiple machine learning model domains. For example, inputs such as those associated with FIG. 3 can be received, including a first indication of the machine learning model 212 domain, a second indication of whether a group of features used by the machine learning model 212 comprises real-time features that consume real-time data, a third indication of a target associated with the machine learning model 212, and/or a fourth indication of ones of the features that are of interest for inclusion in the machine learning model 212.

Example operation 1006 comprises using the data 213 descriptive of the machine learning model 212 and the feature importance information 224 and/or 234 to identify a recommended feature 214 among features stored in a machine learning feature store 204, wherein the recommended feature 214 is represented in the machine learning model domain. Operation 1006 can be performed, for example, by the recommendation engine 202.

In an embodiment, using the data 213 and the feature importance information 224 and/or 234 to identify the recommended feature 214 comprises determining a probability of use of the recommended feature 214 in the machine learning model 212 based on the feature importance information 224 and/or 234. Determining the probability of use of the recommended feature 214 in the machine learning model 212 can be further based on user profile data of user 210, associated with the data 213 descriptive of the machine learning model 212. The user profile data can be associated with a user identity of user 210, and the user profile data can comprise various data discussed herein in connection with FIG. 2, e.g., search history data associated with the user identity.

FIG. 11 is a block diagram of an example computer that can be operable to execute processes and methods in accordance with various aspects and embodiments of the subject disclosure. The example computer can be adapted to implement, for example, any of the various network equipment described herein.

FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a device comprising a processor, a first input, wherein the first input comprises data descriptive of a machine learning model associated with a machine learning model domain;
using, by the device, the first input to identify a feature among features stored in a machine learning feature store,
wherein the features stored in the machine learning feature store are associated with multiple different machine learning model domains,
wherein the identifying is based on a probability of use of the feature by the machine learning model being higher than other probabilities of use of other features stored in the machine learning feature store; and
recommending, by the device, the feature for inclusion in a group of features used by the machine learning model.

2. The method of claim 1, wherein using the first input to identify the feature comprises using the first input to determine the probability of use of the feature.

3. The method of claim 1,
wherein using the first input to identify the feature comprises using the first input to identify multiple features, comprising the feature, among the features stored in the machine learning feature store, wherein multiple probabilities of use, comprising the probability of use, of the multiple features by the machine learning model are higher than the other probabilities of use of the other features stored in the machine learning feature store,
wherein the recommending comprises recommending the multiple features for inclusion in the group of features used by the machine learning model, and the method further comprising:
receiving, by the device, feature selections from among the multiple features; and
storing, by the device, the feature selections for subsequent probability of use determinations associated with the multiple features.

4. The method of claim 1, further comprising:
receiving, by the device, feature importance information indicating an importance of the feature determined by the machine learning model; and
storing, by the device, the feature importance information for subsequent probability of use determinations associated with the feature.

5. The method of claim 1, further comprising:
receiving, by the device, a second input, wherein the second input comprises a feature search input;
searching, by the device, the features stored in the machine learning feature store to identify search results, the search results comprising result features associated with the feature search input; and
sorting, by the device, the search results based on respective probabilities of use of the search results by the machine learning model.

6. The method of claim 5, further comprising storing, by the device, the second input for subsequent probability of use determinations.

7. The method of claim 1, wherein the probability of use of the feature is a first probability of use of a first feature, wherein the other probabilities of the other features are first other probabilities of first other features, and further comprising:
storing, by the device, a user profile comprising a user identifier and the first input;
using, by the device, the user profile to identify a second feature among the features stored in the machine learning feature store,
wherein the second feature is identified based on a second probability of use of the second feature in connection with the user profile being higher than second other probabilities of use of second other features stored in the machine learning feature store; and
recommending, by the device, the second feature to in connection with the user profile.

8. The method of claim 7, wherein the user profile is a first user profile, and further comprising determining, by the device, the second probability of use of the second feature at least in part by evaluating a similarity of the first user profile and a second user profile, wherein the second feature is associated with the second user profile.

9. The method of claim 7, further comprising recommending, by the device, a recently stored feature in connection with the user profile.

10. The method of claim 1, wherein the data descriptive of the machine learning model associated with the machine learning model domain comprises at least one of:
a first indication of the machine learning model domain;
a second indication of whether the group of features used by the machine learning model comprises real-time features available in real-time;
a third indication of a target associated with the machine learning model; and
a fourth indication of which features are of interest in connection with the machine learning model.

11. A device, comprising:
a processor; and
a memory that stores executable instructions that, when executed by the processor, facilitate performance of operations, comprising:
receiving a feature search input, wherein the feature search input is associated with a user profile;
based on the feature search input, searching a machine learning feature store in order to identify search results, the search results comprising features associated with the feature search input;
based on data associated with the user profile, determining respective probabilities of use of the search results; and
sorting the search results based on the respective probabilities of use of the search results.

12. The device of claim 11, wherein the data associated with the user profile comprises model data descriptive of a machine learning model associated with a machine learning model domain.

13. The device of claim 11, wherein the user profile is a first user profile, wherein the data associated with the user profile is first data, and wherein determining the respective probabilities of use of the search results is further based on second data associated with a second user profile.

14. The device of claim 13, wherein the second data comprises feature selections associated with the second user profile.

15. The device of claim 13, wherein the second data associated with the second user profile comprises feature importance information determined by a machine learning model associated with the second user profile.

16. A non-transitory machine-readable medium, comprising executable instructions that, when executed by a processor, facilitate performance of operations, comprising:
receiving feature importance information determined by machine learning models, wherein the feature importance information comprises feature importance information associated with multiple features, and wherein the multiple features are from multiple machine learning model domains;
receiving data descriptive of a machine learning model associated with a machine learning model domain of the multiple machine learning model domains; and
using the data descriptive of the machine learning model and the feature importance information to identify a recommended feature among features stored in a machine learning feature store, wherein the recommended feature is represented in the machine learning model domain.

17. The non-transitory machine-readable medium of claim 16, wherein using the data and the feature importance information to identify the recommended feature comprises determining a probability of use of the recommended feature in the machine learning model based on the feature importance information.

18. The non-transitory machine-readable medium of claim 17, wherein determining the probability of use of the recommended feature in the machine learning model is further based on user profile data associated with the data descriptive of the machine learning model.

19. The non-transitory machine-readable medium of claim 18, wherein the user profile data is associated with a user identity, and wherein the user profile data comprises search history data associated with the user identity.

20. The non-transitory machine-readable medium of claim 16, wherein the data descriptive of the machine learning model comprises at least one of:
a first indication of the machine learning model domain;
a second indication of whether a group of features used by the machine learning model comprises real-time features that consume real-time data;
a third indication of a target associated with the machine learning model; and
a fourth indication of ones of the features that are of interest for inclusion in the machine learning model.
